(19) United States
(12) Patent Application Publication
(10) Pub. No.: US 2005/0207079 A1
(43) Pub. Date: Sep. 22, 2005

(54) System and apparatus for a multifunctional powerline carrier device with data management and power surge protector

(76) Inventors: David S. Tiller, Goodlettsville, TN (US); Charles Edwin Roos, Nashville, TN (US)

Correspondence Address: David Tiller, 2415 Union Hill Rd., Goodlettsville, TN, 37072, US

(21) Appl. No.: 11/084,248

(22) Filed: Mar. 17, 2005

Related U.S. Application Data
(60) Provisional application No. 60/554,066, filed on Mar. 17, 2004.

(51) Int. Cl. H02H 3/00

(52) U.S. Cl. 361/64

(57) ABSTRACT

A multifunction powerline carrier device with power and surge protector discloses a system and describes an apparatus which provides an interface to both a digital and electric network supplying data and power management, power surge protection, voltage analysis and correction, and network connectivity options to electric and electronic devices plugged into or connected to the invention.

### CROSS REFERENCE TO RELATED APPLICATIONS

Provisional Patent Application filed by David Tiller, Goodlettsville, Tenn., the Co-applicant and co-inventor here, as a Small Entity, Titled, “Powerline Carrier Device with Power and Data Surge Protector”, filing date: Mar. 17, 2004, Application No. 60/554,066

### STATEMENT REGARDING FED SPONSORED R&D: N/A

REFERENCES - PRIOR ART

| | Prior Art | |
|---|---|---|
| | References Cited (Referenced By) | |
| 4125276 | July 1980 | Janeway |
| 4899129 | February 1990 | MacFadyen, et. al. |
| 4899217 | February 1990 | MacFadyen, et. al. |
| 5066939 | November 1991 | Mansfield, Jr. |
| 5289365 | February 1994 | Caldwell, et. al. |
| 5424587 | June 1995 | Federowicz |
| 5684710 | November 1997 | Ehlers, et. al |
| 5805458 | September 1998 | McNamara |
| 5864284 | January 1999 | Sanderson |
| 5906517 | May 1999 | Crane |
| 5965487 | September 1999 | Venkatraman, et. al. |
| 6034988 | March 2000 | VanderMey, et. al. |
| 6055144 | April 2000 | Reid |
| 6389122 | May 2002 | Park |
| 6081519 | June 2000 | Petler |
| 6157529 | December 2000 | Ahua |
| 6661634 | December 2003 | Roberts, Jr. |
| 6608899 | August 2003 | Spooner, et. al. |
| 6618772 | September 2003 | Kao, et. al. |
| 6680839 | January, 2004 | Napiorkowski |
| 20040024913 | February 2004 | Ikeda, et. al. |
| 6692270 | February 2004 | Bencivenga, et. al. |
| 6704181 | March 2004 | Saksa |
| 6721155 | April 2004 | Ryman |
| 6731201 | May 2004 | Bailey, et. al. |
| 6738474 | May 2004 | Miller |
| 6741162 | May 2004 | Sacca, et. al. |
| 6744150 | June 2004 | Rendic |
| 6759762 | July 2004 | Barton |
| 6785110 | August 2004 | Bartel, et. al. |
| 20040156159 | August 2004 | Liebenow |
| 6671155 | December 2004 | Bennett, et. al. |
| 20050002142 | January 2005 | Chuch, et. al. |
| 6584015 | February 2005 | McCormack, et. al. |

### OTHERS REFERENCES

Gellings, George, “Powering the Next Century: Scenarios of Change in the Way People Interact with Buildings,” Consortium for Electric Infrastructure to Support a Digital Society, Electric Power Research Institute and the Electricity Innovation Institute: Primen, 1001 Fourier Drive, Madison, Wis., 53717

“Smart Power Grid Recornmendations: What is a Smart Grid, and Why is it Important?” Energy Future Coalition, 1225 Connecticut Ave., Washington, D.C., 20036

Samotiyj, Marek, and Forsten, Karen, “Delivering Digital Grade Power,” Electric Power Research Institute(EPRI)-PEAC Corporation, Knoxville, Tenn., April, 2002.

“What is a power quality problem?” EPRI-PEAC Corporation, Knoxville, Tenn., www.epri-peac.com, online publication.

“PQ Application 4: Eliminating the Jitters in Computer Monitors,” Electric Power Research Institute—PEAC Corporation, Knoxville, Tenn.

“The IEEE P1413 Draft Standard Methodology for Reliability Prediction and Assessment for Electronic Systems and Equipment: principles and approaches to the documented methodology for reliability prediction and assessment for electronic systems and equipment,” www.ieee.org, online publication, Institute of Electrical and Electronic Engineers, IEEE Computer Society

### TECHNICAL FIELD OF THE INVENTION

The present invention relates to electrical switching, controlling, analyzing and regulating devices and methods, as well as data transmission, utilizing the same or parallel electrical and data media, including electric wires, employed for delivering electric power to the said devices and methods, and more specifically a central processing unit controlled power and data outlet strip outlet, in one embodiment, which dynamically configures, corrects, and controls power and data delivered over said media, including electric wires, to all devices connected to said apparatus.

### BACKGROUND OF THE INVENTION

According to the Electric Power Research Institute, EPRI, power outages and power quality disturbances cost U.S. businesses in excess of $100 billion annually. Catastrophic blackouts, such as the August 2003 event which left millions without electricity, can up the damage estimates 100% or more above the EPRI estimates, published before the 2003 blackout event. EPRI and other organizations such as the Energy Future Coalition have published white papers and articles calling for a “Smart Grid” enabling the North American Power Grid (NAPG) to deliver “digital grade power” to the more than 12 billion microprocessors in devices ranging from TVs to dishwashers, ovens, HVAC equipment, and video game consoles, all of which as of 2004 were powered by electricity. In March of 2003, the Consortium for Electric Infrastructure to Support a Digital Society, CEIDS, which includes EPRI and other groups, developed objectives for “industry wide enterprise architecture for the self-healing grid and integrated consumer communications interface.”

One proposed component of an integrated consumer communications interface has been the expansion in the deployment of broadband over powerline (BPL) and/or powerline carrier (PLC) technologies, the former being generally accepted as the term describing high bit-rate, high speed digital data over electric wires. BPL now enables digital subscriber line (DSL) rates of service to home and business users of the Internet, while PLC has come to mean lower bit rate, lower speed service and delivery of data such as supervisory control and data acquisition (SCADA) for the utility companies' own internal use regarding line conditions, outages, power management and other essential information. Prior art referred to above, including Sanderson, U.S. Pat. No. 5,864,284 (January 1999) and Mansfield, U.S. Pat. No. 5,066,039 (November 1991) describe method and means of operating a powerline carrier communications system and coupling radio frequency signals to and from a power distribution network, and Sanderson, an associate of the applicants here, has deployed pilot test sites of his invention in both South Carolina and Washington state.

An essential purpose of a consumer communications interface, such as described herein and in the applicants' invention, is to assist in the monitoring of the electric power grid itself, since the anticipated “smart grid” must utilize existing and future technology to operate more efficiently and more safely as well, from the consumers' premises, to the electric substations, transmission and distribution hubs, and to all components of the NAPG, and back.

At the consumers' premises, according to EPRI and other organizations, there is a need to deliver “digital grade power” to provide more efficient use of the NAPG infrastructure and to cut down on the $100 billion in losses to businesses and household consumers and their microprocessor controlled equipment and appliances which fail or “fry” in power surges and spikes. Central processing units, digital signal processors, power management circuitry, and other technologies exist and are becoming cheaper as solid state, systems on a chip are deployed in both more hardened and smaller form factors. Much of the same technology can be combined and integrated in innovative architectures, as the applicants' invention seeks to attest, to deploy equipment at the electric power consumers' premises to not only supply digital grade electric power, and secure synchronous data over powerlines, but to potentially provide new levels of safety in power surge and data surge protection for consumers' equipment and appliances, another desirable objective outlined by EPRI. Even when the quality of delivered power is perfect, according to EPRI, equipment in the same facility protected by the same circuit breaker can cause neighboring equipment to malfunction. There is a real need, then, for inventions that provide equipment monitoring functions in order to maintain what EPRI calls “a state of system compatibility” as occurs when the said equipment and appliances get along in the same electrical environment.

### SUMMARY OF THE INVENTION

A multifunction powerline carrier device with power and surge protector discloses a system and describes an apparatus which provides an interface to both a digital and electric network supplying data and surge power protection, voltage analysis and correction, and power and data management to electric and electronic devices plugged into or connected to the inventors' apparatus.

The inventors' system and apparatus in one embodiment comprises a power and datastrip outlet, adapted to engage an electrical plug, and other connections as described herein; a central processing unit (CPU) which includes a server and router and radio frequency transceiver electrically and electronically coupled to powerline input and output; a digital signal processor (DSP) capable of, but not limited to, analyzing noise and radio frequency (RF) signals, along with power management circuitry (PMC) embedded in said CPU. External power from the electric utility and external and internal data, including but not limited to Internet data, voice and video, is in circuit communication with the CPU, DSP, and the PMC and employs circuitry for selectively analyzing and determining voltage parameters as well as RF and other noise, including the RF which is the broadband and/or narrowband data stream broadcast over the electric wire. The analysis and method of both electrical power and data signals occurs in specific steps within the inventors' apparatus, with the first step consisting of the CPU and attendant circuitry analyzing data rates and providing forward and backward bit error correction, and grooming and repeating and/or amplifying digital signals; and the second and almost simultaneous step consisting of, but not limited to, the analysis of voltage, amperage and other electromagnetic parameters while conducting Fast Fourier analysis and correcting voltage spikes and sags, and other deleterious conditions. One preferred embodiment provides a multi-outlet powerstrip supplying what the Electric Power Research Institute and the Institute of Electrical and Electronic Engineers describes as “digital grade” electric power to sensitive microprocessors in appliances and electronic devices, while serving as a repeater and digital electronic signal processor and enhancer for broadband over electric lines(BPL) also known as powerline carrier (PLC) service(s) broadcast over the same or different electric wires connected to or plugged into the inventors' apparatus.

The present invention discloses a system, describing an apparatus which may be used by both the consumer and the supplier of electricity which is carried and transmitted on the same wires as the narrow band and broad band data, voice and video transmitted on the said electric wires which may be low, medium or high voltage lines typically delivered and supplied to buildings and other structures by electric utilities and/or the broadband over powerline (BPL) and/or powerline carrier (PLC) service providers.

The subject invention, in one embodiment as a power and datastrip outlet, may comprise electrical outlet plugs, coaxial cable connections, digital satellite and TV/HDTV connections, Ethernet connections, and phone plug connections. Typically, an electrical outlet into which a device's three prong plug attaches, has three slots, one for each of the prongs on a power cord: a neutral slot, a hot slot, and a grounding slot. Surge protectors and suppressors commonly found in prior art differ in how they handle passing current among the various slots, and they typically are offered in two types: MOVs, which are metal-oxide varistors, and series mode. MOVs have a series of tiny MOV disks that use semiconductors on each side to connect the hot wire to the grounding wire. When voltage increases, the MOVs lessen their resistance, and excess voltage passes through to the grounding wire. Series-mode surge protectors absorb excess voltage and then gradually let the current pass through the hot wire after the surge ends. An MOV protector could send excess electricity through a grounding wire, which could then surge through a phone line connected to the modem of a computer (PC). The applicants' invention teaches the use of said CPU, DSP, PMC and attendant circuitry to interface with a series mode suppressor said suppressor to interface with each said connection and between each said connection to a user's electric and electronic appliances and equipment in the said preferred embodiment.

2. Related Art

A co-inventor in this application, Dr. Charles E. Roos, and his invention, “Utility meter providing an interface between a digital network and home electronics,” U.S. Pat. No. 5,699,276, (December 1997) distinguished his invention from prior art by noting that said prior art sought to control home appliances over electric wire by digital and analog communications systems that were not contained in or attached to the electric meter or meter box. Roos' said utility meter invention provides a method and apparatus to interface with home electronics through an electric meter or meter box. Citing prior art from MacFadyen, et. al., U.S. Pat. No. 4,899,129, (February 1990) and from Mansfield, U.S. Pat. No. 5,066,939, (November 1991) in said Roos invention, as here, the present applicants' invention teaches that an interface between a powerline carrier system (PLC), and/or a broadband over powerline (BPL) system, and a multifunction surge suppressor and BPL/PLC device comprises innovative and utilitarian functions for the electricity consumer in the home, or other structure, and for the utility and/or other company supplying the power and data to the applicant inventors' apparatus. The applicants' data and surge protection system and apparatus is in one embodiment contained within a data and powerstrip outlet comprising a CPU and DSP for synchronous communication with home electronics and with the electric utility to allow and enable power management control (PMC), and enhanced or “digital grade power”, the phrase frequently used by the Electric Power Research Institute (EPRI) to describe power delivered to sensitive microprocessor controlled equipment without surges, sags or other potentially damaging characteristics.

The present invention also is distinguished from said Roos patent in that the present invention, in one embodiment, is a multifunction data and powerstrip device optimally located within a utility consumer's premises, and is not a utility meter located outside said premises, and the interface function of the present invention is with home electronics, appliances and circuit breakers as well as with the electric utility and/or its broadcast data service provider(s).

Powerstrip and electric outlet strip inventions, such as Crane, et. al, U.S. Pat. No. 5,906,517, (May, 1999) teach that a power strip “electrical connector may include a circuit board which may contain an on/off switch and a circuit breaker with surge suppression”, and a plug with a built in ground fault circuit interrupter(GFCI), but said prior art does not integrate these functions dynamically for purposes of millisecond power and data analysis and correction through a CPU and DSP with a PMC circuit, nor does the Crane prior art teach synchronous communication with devices to which the power strip is connected, nor does the said prior art teach technology for the correction of voltage sags, nor does the said prior art teach an electronic interface between a series mode surge suppressor and a CPU/DSP/PMC circuitry architecture.

Saksa, U.S. Pat. No. 6,704,181 (March 2004) disclosed “a ‘smart’ power circuit protection system in which the trip level of a circuit breaker is dynamically set based upon information communicated from load over the power lines”, and the invention “is adaptable to configurations involving multiple loads protected by a single circuit breaker and an adapter permits loads not incorporating a ‘smart’ current reporting capability to be included in the circuit breaker load’, which is similar to the applicants' invention in function, but which relies entirely on time-based fault detection for circuit breaker function. In Saksa's invention, load reporting by data delivery over electric wire from smart appliances is disclosed, but the said art requires an adapter for dumb appliances and devices. The applicants' invention utilizes the CPU, DSP and PMC circuitry functions described herein to allow the inventors' apparatus to determine proper load delivery from a summing of the load requirements of connected devices, whether smart or dumb, while simultaneously analyzing and correcting, as necessary, dysfunctional current, amperage and voltage conditions, along with the data being sent synchronously to report and correct those conditions. Like the said Saksa invention, the applicants' method and apparatus sets a trip level in a power circuit protection device based on load parameters of connected devices and equipment, but the applicants' art is the said CPU and attendant circuitry interface with a series mode surge protector in addition to alarm algorithms which serve a circuit breaker function. The applicant's method is in contrast to Saksa's time-based method, which breaks a circuit only when there is a lag in data reporting over the electric wires connecting the said Saksa apparatus to the loads, appliances and equipment on the circuit as outlined in the Saksa invention. The applicants' powerstrip which is also a datastrip dynamically analyzes, regulates, amplifies and/or corrects data and power as the power and data is then passed from the applicants' apparatus to the connected appliances and devices. The applicant's invention does not depend for its circuit breaker function solely on the presence of voltage or current sags, since the inventors' method teaches correction of those and other deleterious conditions before the alarm and circuit breaking functions are triggered. This means that in addition to the alarm based functionality of the applicants' method and apparatus, as opposed to the time-based functionality of said Saksa invention, the circuit breaker function would not be called into use except in the most catastrophic situations of, for example but not limited to power surges or sags, and/or both. Also, unlike the Saksa invention, the applicants' invention teaches a method of establishing a virtual circuit breaker for each device attached to the applicants' apparatus, as well as to the applicant's apparatus itself, so that the appliances attached to the applicants' apparatus are operating in a state of system compatibility and will continue to operate in that said state even if one or more of said appliances have received circuit breaking instructions from the applicant inventors' apparatus.

### BRIEF DESCRIPTION OF DRAWINGS

FIG. 1 is a perspective view of the main elements and technologies of the system and apparatus which illustrates the electric wire transmitting both power and data from the utility to the apparatus by way of the electric meter and the internal wiring of the user's home or other structure.

FIG. 2 shows a block diagram of a second embodiment according to the invention which provides data and power connectivity as well as monitoring of reporting, connected appliances.

FIG. 3 shows a block diagram of a third embodiment a system and apparatus for a data and power surge protector, illustrating several connection options for various appliances and electronic equipment.

### DETAILED DESCRIPTION OF THE PREFERRED EMBODIMENTS

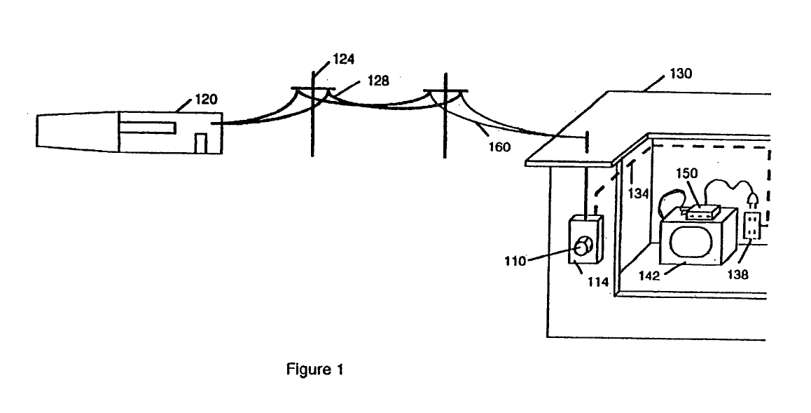

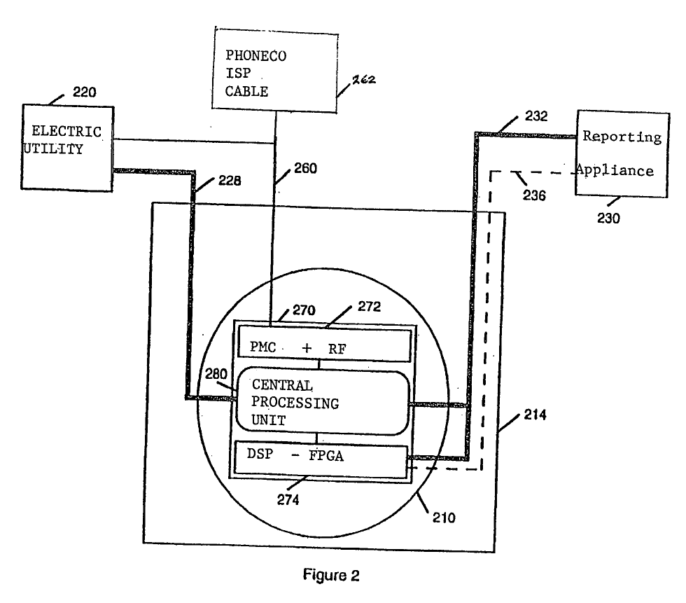

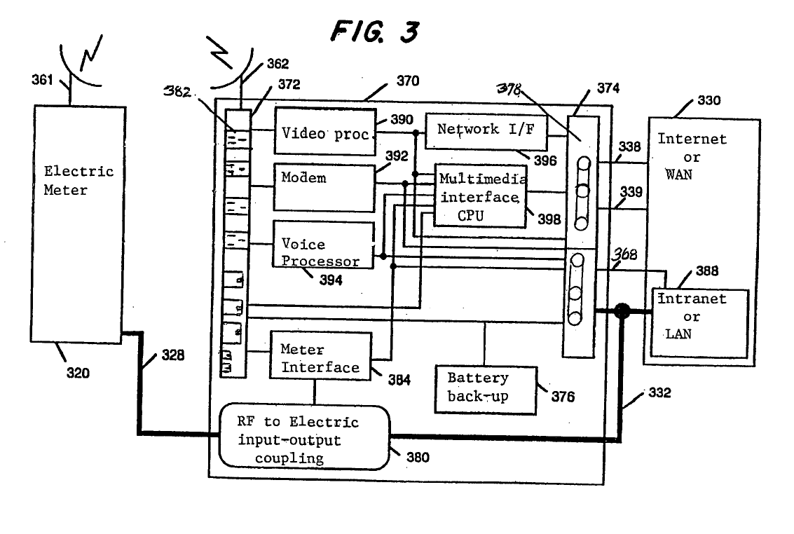

FIG. 1 shows a perspective view of a first embodiment of an apparatus according to the invention, illustrating the electric utility, 120, with electric wires transmitting power and data, where data transmission requires repeaters 124 and 128, as well as 160 and 150, one of the features of the first embodiment of applicant's invention. A standard meter box 114 with a standard meter 110 is shown since these components are also essential in order to deliver both data and digital grade electric power through the structure's internal wiring 134 to the terminal point of the plug 138, into which the inventor's apparatus 150 can attach and connect, while appliances and electronic equipment 142 in the structure plug into inventors' apparatus as shown. Interactive equipment, driven by microprocessors, including PCs, laptops and Internet enabled appliances, can plug into this embodiment of said apparatus at points more fully illustrated in FIGS. 2 and 3.

FIG. 2 is a block diagram in close perspective illustrating a second embodiment of the applicant's invention and features which may be found when this second embodiment of the invention is part of a circuit breaker and alarm reporting system 214, as opposed to a power and data strip as illustrated in FIG. 3.

In FIG. 2, the electric utility 220 is supplying both data and power over the electric line requiring a repeater 228 and 274 in order to deliver robust data to the reporting appliance 230. The reporting appliance is in two way communication with the CPU 280 over the electric wire 232. The phone wire or coax cable 236 illustrates the feature in this embodiment of a reporting appliance or PC that uses a separate Internet or data communication connection, also enabled in this embodiment., connecting to the data side of the CPU 274 which comprises a digital signal processor DSP and may provide a firewall feature for Internet connected reporting appliances and equipment 230.

The DSP 274 also processes information regarding voltage current and reactive power as well as digital data and is part of the architecture for determining, based on information gathered and analyzed, whether a series surge protector will kick in or a circuit breaking will occur based on both input from electric current and data over wire 228 and reporting over wire 232. CPU 280, along with embedded circuitry in DSP 274 and RF and power management circuitry in 272 provide for dynamic management of both data and power on the power input side 228 and the power output side 232, as well as the reporting side 232 and 214 of inventor's apparatus. Preset and intuitive alarm systems are featured in this embodiment of the subject invention, enabling the circuit breaking function described herein. Automatic alarms can be set by either the user or the utility for notifying the utility company 220 by data over electric wire 228 or phone or coax 260. The further ability of the apparatus to offer optional services is illustrated; services such as video security, to users who can themselves monitor data, including video data, as well as power and climate conditions from their premises or from the Internet off site are enabled by cable or DSL connections to the phone company, cable service provider or internet service provider 262, or all of these. Those experienced in the digital electronic arts are developing smaller form factors and systems on a chip 270 that will easily be accommodated by a circuit breaker system or enclosure 214 in this embodiment of the invention. The power managemnet circuitry, PMC 272 and the DSP 274 may both be systems on a chip with field programmable gate array (FPGA) features, enabling remote configuration by the utility company, especially in the embodiment shown in FIG. 3.

The CPU 280 and attendant circuitry 272 and 274 as described will support control technologies that are either synchronous or asynchronous, in any of the three embodiments of the invention illustrated in the three figures. In asynchronous serial communication, the electrical interface is held in the mark position between characters. The start of transmission of a character is signaled by a drop in signal level to the space level. At this point, the receiver starts its clock 210. After one bit time (the start bit) come 8 bits of true data followed by one or more stop bits at the mark level. The receiver tries to sample the signal in the middle of each bit time. The byte will be read correctly if the line is still in the intended state when the last stop bit is read. In synchronous communications, data is not sent in individual bytes, but as frames of large data blocks. Frame sizes vary from a few bytes through 1500 bytes for Ethernet or 4096 bytes for most Frame Relay systems.

The clock 210 is embedded in the data stream encoding, or provided on separate clock lines 210 such that the sender and receiver are always in synchronization during a frame transmission.

FIG. 3 illustrates a third embodiment of the applicants' invention wherein the multifunctional data and power surge protector is configured as a multi-media data and powerstrip. This apparatus features a number of connection options, including standard three prong plugs, Ethernet and phone plugs 382, and co-axial cable and fiber optic 378 receptacles. Specific types of appliances and Internet enabled equipment may be plugged into the apparatus in this embodiment in order to supply particular connectivity, reporting and power quality options 382, where a video 390 and network interface 396 offer fiber optic 338 bandwidth and speeds. In another example, network interface 396 may function as a computer switch and communication line 338 may comprise a fiber optic cable: a computer switch operating in conjunction with a fiber optic connection to a digital service network can receive several hundred channels of information. Interface 396 may also be in communication with a home electronic device, such as a video monitor, and may, in response to a request from the home electronic device, function to select a desired channel for transmission over the internal power lines 332 and/or other internal wiring to the home electronic device 142. Network interface 396 may be further operative to descramble signals and provide billing information.

The electric company's meter 320 in this embodiment provides digital data services via network wireless transmission device 361 and over fiber optic cables 338, coaxial cables 339, and twisted pair cables 368. All connectivity options can be configured or coupled to the digital data services through network interface 396.

Network interface 396 also provides a remote wireless transmission device 362 to communicate with network wireless transmission 361. This wireless means of communications could complement the powerline carrier and/or BPL services provided by the utility, especially in the event of a power outage or other emergency where the battery backup 376 would engage in order to allow such communication or alarm. Such wireless communication might also include transmitting and receiving signals over a selected microwave frequency channel. Data transmission on the selected frequency channel might include such techniques as token ring data transmission, spread spectrum transmission, and/or packet data transmission. Alternatively, wireless transmission media might include infrared, optical, cellular, or satellite communications. Most digital satellite television manufacturers now require connection to an advanced high capacity multi media power surge protector in order to maintain the products warranty.

The illustrated embodiment in FIG. 3 also provides a video processor 390, a modem processor 392, a voice processor 394, and a meter interface 380, all of which are coupled to network interface 396, co-axial and fiber plug panel 374, and the twisted pair, Ethernet and plug in panel, 382. Multi media interface 398 is configured for both receiving and transmitting their respective signals.

Since battery backup 376 can supply power to the apparatus 370, in the event of a power failure, a global positioning (GPS) system in 398 may be operative in an emergency and could broadcast the position of the apparatus, and the condition of the power supply through the phone line, cable, or electric wires, in addition to the wireless system referred to above.

Video processor 390 is further coupled to a descrambler in the modem processor 392 for providing descrambled video signals to the network interface, in order that a utility or other service provider could deploy the inventors' apparatus in this embodiment not only as a safety device and home networking appliance, but as a low cost set top box able to provide self configuring services to subscribers over several connectivity options. Network interface is coupled to PC interface 398. Network interface 372 is further coupled directly to house interface 374 for passing signals through without other processing.

Network interface 374 is coupled to the premise's internal wiring 332, telephone lines 368, and television coaxial cables 339. Network interface 374 may also act as a hub for all connectivity options and communicate with home electronics via wireless communication. For example, cordless telephones and IEEE 802.11a/b/g devices communicate over short range microwave signals. The network interface 396 may utilize similar short range wireless communication in order to facilitate home automation options for the user.

1. A power and data surge protector interface system and apparatus comprising:
a) a connection or connections by electric wire between a utility company and said apparatus and between said apparatus and a utility user's electric and electronic appliances and equipment plugged in or connected to said apparatus, said interface apparatus also comprising:
b) a central processor unit including a server and router and radio frequency receiving circuitry electrically and electronically coupled to the powerline input and output, a digital signal processor and data and electric power management circuitry; and a housing for said processor unit and circuitry;
and wherein control logic in the said processor unit and attendant circuitry in a sequence timed by said processor unit analyzes, controls, corrects, amplifies and routes the data received over the electric wire from the utility and from the said appliances and equipment connected to said apparatus, and thence to and through said apparatus and to the said connected appliances and equipment, and to the said utility and/or the Internet to which said user's said equipment may also be connected; and wherein control logic in said processor unit and said circuitry in a timed sequence analyzes, corrects, controls and routes electric power from the said utility to said utility user's said electric and electronic appliances and equipment, while also supplying surge suppressor protection to itself and through said interface, connected to a series mode power surge suppressor, to the said electric and electronic appliances and equipment.

2. A power and data surge protector interface system and apparatus as recited in claim 1, wherein said housing comprises one or more plug receptacles for electric and electronic appliances to attach, and one or more connections for Ethernet, phones, TV/HDTV, and other multi-media applications, including wireless and fiber optic applications benefiting now or in the future from data and power surge protection and power management.

3. A power and data surge protector interface system and apparatus as recited in claim 1, wherein a power circuit breaker having an adjustable setting for current trip level and having internal logic to send and receive messages transmitted over the power line to said system and apparatus from multiple loads on said appliances and equipment protected by the breaker, to determine the total current requirements of the multiple loads based on the said message contents, and to set the trip level accordingly; and control logic from the said system and apparatus to each of the multiple loads protected by the breaker to determine the operating current required by the load, and to transmit over the power line to the circuit breaker a message whose contents indicate the load requirements, as well as analyzing, correcting and controlling the incoming voltages and currents to said appliances and equipment.

4. A power and data surge protector system and apparatus interface as recited in claim 1, wherein the control logic from said apparatus sent to and received from each of the loads further transmits messages to, and receives messages from the said apparatus at rates based on both reports from the appliances and equipment connected to the said apparatus and from the incoming power and current from the utility to said apparatus, and the internal logic of the said apparatus can, after exceeding capacities of the said series mode surge suppressor described in 1, above, cause the breaker to trip if messages from the appliances and/or the utility exceed set parameters described in 3, above. The same parameters will also determine when and if the breaker can be reset.

5. A power and data surge protector system and apparatus as recited in claim 1, wherein the said central processor unit and attendant circuitry establishes a virtual circuit breaker or software switch for itself and for each appliance or load plugged into or connected to the said apparatus, such said circuitry and software being familiar to those teaching the established art of packet switching of digital data, and relying on the said parameters, reports, and measurements described in 1-4, above, with the purpose being to test such virtual circuits in real time and continuously based on said parameters, reports and measurements, and if necessary to break such virtual circuits first, before the actual line circuits are broken, in order to determine the effect on all the other said appliances, equipment and loads connected to the said apparatus.

6. A power and data surge protector system and apparatus housed within a circuit breaker box or other circuit hub environment, comprising:
a) a connection or connections by electric wire between a utility company and said apparatus and between said apparatus and a utility user's electric and electronic appliances and equipment connected to said apparatus, said interface apparatus also comprising:
b) a central processor unit including a server and router and radio frequency receiving circuitry electrically and electronically coupled to the powerline input and output, a digital signal processor and data and electric power management circuitry;
and wherein control logic in the said processor unit and attendant circuitry in a sequence timed by said processor unit analyzes, controls, corrects, amplifies and routes the data received over the electric wire from the utility and from the said appliances and equipment connected to said apparatus, and thence to and through said apparatus and to the said connected appliances and equipment, and to the said utility and/or the Internet to which said user's said equipment and said apparatus may also be connected; and wherein control logic in said processor unit and said circuitry in a timed sequence analyzes, corrects, controls and routes electric power from the said utility to said utility user's said electric and electronic appliances and equipment, while also supplying surge suppressor protection to itself and through said interface, connected to a series mode power surge suppressor, to the said electric and electronic appliances and equipment.

7. A method of protecting and enhancing power and data circuits powering electrical and/or electronic equipment, comprising:
a) sending and receiving messages from said equipment, over the same power lines powering said equipment, and having said power lines with hot and neutral lines, and
b) the hot line interruptible by a line circuit breaker after a central processor to which the line is connected first tests the circuit and conducts such tests in real time in a virtual circuit breaker environment which may include other loads and other equipment on the circuit in addition to the said equipment before breaking the actual line circuit, and
c) based on information parameters generated by the said equipment and by the incoming power to said central processing unit, and the outgoing power from said unit to the said equipment, said processing unit determines whether to route power to a series mode surge suppressor or to break the circuit, and if and when to reset the same circuit.
